(19) United States
(12) Patent Application Publication
(10) Pub. No.: US 2026/0278524 A1
(43) Pub. Date: Sep. 17, 2026

(54) Method for Optimized Luggage Transportation

(71) Applicants: Guillermo García Franco, Nuevo León (MX); Gael García Guzmán, Nuevo León (MX)

(72) Inventors: Guillermo García Franco, Nuevo León (MX); Gael García Guzmán, Nuevo León (MX)

(21) Appl. No.: 19/079,575

(22) Filed: Mar. 14, 2025

(51) Int. Cl. G06Q 10/0835; G06Q 10/0833

(52) U.S. Cl. CPC G06Q 10/08355; G06Q 10/0833

(57) ABSTRACT

Methods and systems for optimizing and managing transportation and delivery of an airline passenger's luggage from a first location to a second location or multiple locations using Artificial Intelligence (AI) to generate route options for pickup, transportation and delivery of the luggage, by selecting the logistics operator that optimizes the delivery, using at least one selection parameter for the transportation of the luggage.

### BACKGROUND

### Technical Field

The present disclosure relates to methods of transporting a passenger's luggage. More particularly, the disclosure relates to a system and method for optimizing and managing the airline passenger's luggage from a first location to a second location or multiple locations integrating the use of Artificial Intelligence (AI) for the selection of the optimal logistics operator for the delivery of said passenger's luggage at said second location or multiple locations.

### Technical Considerations

Over the years, there has been a considerable increase in world air traffic. In 2004 there were approximately 2000 million passengers and by 2020 (pre-pandemic) it reached approximately 4700 million passengers and in 2022 there were close to 3800 million passengers. With this increase in passengers, there has also been a significant increase in luggage handling at airports, so there is also a higher probability of failure within the airport system at the time of collection, documentation, transportation and delivery of luggage.

Typically, the passenger must go with the luggage to the airport to be checked in, having to be there at least 2 or 3 hours before the departure of the flight and check in the luggage, depending on the destination and travel season. The attention to the passenger at the airport will depend on the policies of the airport, as well as the personnel of the airline in which the passenger will travel, which may create complications in the transportation of the passenger to the destination.

During luggage check-in, the luggage is measured and weighed, and depending on its weight and size, it is either delivered for documentation to be placed in the cargo area of the aircraft, or it is kept by the passenger as carry-on luggage to be carried inside the aircraft cabin. Currently, it is common for carry-on luggage to overcrowd the aircraft cabin and have to be carried under the seats or in compartments that are sometimes relocated by aircraft personnel or other passengers during takeoff preparation.

The passenger must pick up the checked luggage that was destined to the cargo area of the aircraft upon arrival at the destination, which may require considerable time for such passenger depending on the airport and the airline, without considering the cases in which connections must be made with other flights, resulting in a significant inconvenience if there is a delay in the flight or to pick up such luggage.

In general, the choice to travel by air is made based on the speed and comfort inherent to this form of transportation. However, the inconveniences related to air travel, such as the need for early arrival at the airport, the transportation and documentation of luggage, the retrieval of such luggage upon arrival at the destination, and keeping an eye on it at all time, often result in an uncomfortable and insecure experience for the passenger, regardless of whether the travel is for business or tourism.

An alternative that minimizes these inconveniences is to travel without luggage, or to carry the least amount of luggage; however, this alternative involves the need to purchase different items at the destination, both personal hygiene items and clothing or other items needed during the trip, which may involve high expenses and may also require the transportation of such items on the return flight.

In the existing technology, there are systems and methods of collecting and delivery luggage that operate by means of different elements and/or stages, such as software or applications. Examples of such systems and methods can be found in patent documents EP4053769, US6807458, US7079921, US7096089, US9659336, as well as in the form of services with providers such as BAGS INC, DIRECT LUGGAGE and, SEND MY BAG, among others. However, the current systems and methods require a high investment for both the service provider and the passenger, considering that a payment is required for the collection and transportation of the luggage in addition to the cost of the passenger's transportation. In view of the above, a system and methods are needed to optimize resources to minimize pick-up and transportation times, as well as to minimize the associated costs for the transportation units or for the transportation from one location to another. Another important aspect is that related to a rigorous control at the time of inspecting the luggage, both to maintain the safety of passengers and crew and to avoid the transfer of prohibited objects. In this situation, a system and methods are required to maintain surveillance over the luggage, but that provide comfort and safety for the passenger, ensuring the safe arrival of the luggage at the proper destination.

### Summary

An objective of the present disclosure is to provide a system and methods that optimize resources to minimize the time to collect and transport an airline passenger's luggage, as well as to minimize the associated costs for the transportation units and/or for moving said luggage from one location to another.

Another objective of the present disclosure is to provide a system and methods which maintain surveillance over an airline passenger's luggage, but which provide convenience and security for said passenger, ensuring the safe arrival of the luggage at the proper destination.

A further objective of the present disclosure is to provide a system and methods for the selection of the optimum logistics operator for the delivery of an airline passenger's luggage at one or more locations.

In still a further objective, the present disclosure provides a system and methods for optimizing and managing the transportation and delivery of an airline passenger's luggage, wherein said passenger can carry on said methods by means of a programmable device or computational system and AI.

An additional objective of the present disclosure is to provide a system and methods for optimizing and managing the transportation and delivery of an airline passenger's luggage that allows for real-time monitoring of the status of said luggage at any time within the method, as well as locating said luggage by GPS.

These and other objectives are achieved by the methods and systems for optimized luggage transportation as described and claimed hereinafter.

### BRIEF DESCRIPTION OF THE DRAWINGS

The terms Fig., Figs., Figure, and Figures are used interchangeably in the specification to refer to the corresponding figures in the drawings.

FIG. 1 is a diagram of a method for luggage transportation in accordance with an illustrative and non-limiting illustrative and non-limiting and non-limiting embodiment according to the principles of the present disclosure;

FIG. 2 is a conceptual diagram of a system for luggage transportation in accordance with an illustrative and non-limiting embodiment according to the principles of the present disclosure;

FIG. 3A1 is a view a user interface via a service application on a mobile device in accordance with an illustrative and non-limiting embodiment according to the principles of the present disclosure, displaying fillable boxes for the registration of a passenger;

FIG. 3A2 is a view of a user interface via a service application on a mobile device in accordance with an illustrative and non-limiting embodiment according to the principles of the present disclosure, displaying fillable boxes for passenger login;

FIG. 3B1 is a view of a user interface via a service application on a mobile device accordance with an illustrative and non-limiting embodiment according to the principles of the present disclosure, displaying a summary of passenger data and luggage shipments;

FIG. 3B2 is a view of a user interface via a service application on a mobile device in accordance with an illustrative and non-limiting embodiment, displaying passenger data;

FIG. 3B3 is a view of a user interface via a service application on a mobile device in accordance with an illustrative and non-limiting embodiment according to the principles of the present disclosure, displaying passenger payment means;

FIG. 3B4 is a view of interface via a service application on a mobile device in accordance with an illustrative and non-limiting embodiment according to the principles of the present disclosure, displaying fillable boxes for the registration of a new passenger payment means;

FIG. 3C is a view of a user interface via a service application on a mobile device, showing in accordance with an illustrative and non-limiting embodiment according to the principles of the present disclosure, displaying a home screen;

FIG. 3D1 is a view of a user interface via a service application on a mobile device in accordance with an illustrative and non-limiting embodiment according to the principles of the present disclosure, displaying fillable boxes for the registration of flight and reservation information;

FIG. 3D2 is the continuation of the view in FIG. 3D1;

FIG. 3E1 is a view of a user interface via a service application on a mobile device in accordance with an illustrative and non-limiting embodiment according to the principles of the present disclosure, displaying fillable boxes for the registration of a first location address;

FIG. 3E2 is a view of a user interface user interface via a service application on a mobile device in accordance with an illustrative and non-limiting embodiment according to the principles of the present disclosure, displaying fillable boxes for the registration of a second location address;

FIG. 3E3 is a view of a user interface via a service application on a mobile device in accordance with an illustrative and non-limiting embodiment, displaying GPS selectable option and fillable boxes for the registration of an address to send a GPS locator device;

FIG. 3E4 is the continuation of the view in FIG. 3E3;

FIG. 3F1 is a view of a user interface via a service application on a mobile device in accordance with an illustrative and non-limiting embodiment according to the principles of the present disclosure, displaying a selectable first luggage parameter (luggage type);

FIG. 3F2 is the continuation of the view in FIG. 3F1, displaying a selectable second luggage parameter interface (luggage size);

FIG. 3F3 is the continuation of the view in FIG. 3F2, displaying a selectable third luggage parameter (luggage model);

FIG. 3F4 is a view of a user interface via a service application on a mobile device in accordance with an illustrative and non-limiting embodiment according to the principles of the present disclosure, displaying the luggage parameters summary;

FIG. 3F5 is a view of a user interface via a service application on a mobile device in accordance with an illustrative and non-limiting embodiment according to the principles of the present disclosure, displaying available routing options;

FIG. 3G1 is a view of a user interface via a service application on a mobile device in accordance with an illustrative and non-limiting embodiment according to the principles of the present disclosure, displaying preloaded payment means and an option for registration of a new payment means;

FIG. 3G2 is a view of a user interface via a service application on a mobile device in accordance with an illustrative and non-limiting embodiment according to the principles of the present disclosure, displaying a deployable summarized shipment information menu;

FIG. 3G3 is the view of the user interface of FIG. 3G2, deploying luggage details;

FIG. 3G4 is the view of the user interface in FIG. 3G2, deploying shipping details;

FIG. 3G5 is the view of the user interface in FIG. 3G2, deploying GPS locator device ID number and payment details;

FIG. 3G6 is a view of a user interface via a service application on a mobile device in accordance with an illustrative and non-limiting embodiment according to the principles of the present disclosure, displaying an order confirmation;

FIG. 3H1 is a view of a user interface via a service application on a mobile device in accordance with an illustrative and non-limiting embodiment according to the principles of the present disclosure, displaying information on active shipment(s);

FIG. 3H2 is the continuation of the view in FIG. 3H1;

FIG. 3I is a view of a user interface via a service application on a mobile device in accordance with an illustrative and non-limiting embodiment according to the principles of the present disclosure, displaying notifications on luggage transport status;

FIG. 3J1 is a view of a user interface via a service application on a mobile device in accordance with an illustrative and non-limiting embodiment according to the principles of the present disclosure, displaying a deployable real-time luggage location tracking menu;

FIG. 3J2 is a view of the interface in FIG. 3J1, displaying tracking details of a first luggage;

FIG. 3J3 is the continuation of the view in FIG. 3J2; and

FIG. 4 is a view of a user interface on a desktop application or on a Web site.

### DETAILED DESCRIPTION

The present disclosure comprises a system and methods for optimizing and managing the transportation of an airline passenger's luggage or equipment from a first location to a second location, implemented through a programmable device or computer system and using Artificial Intelligence (AI). The design, assembly and implementation of the mathematical and operational model between a graph system with “weights” to identify the best route and recursive non n-ary (non-binary) tree systems to make a search among the available options, integrated with at least one search engine, allows locating suitable airlines and logistics operators through at least one selection parameter for the transportation of the luggage from a first location to a second location with each of their routes, prices, times and constraints.

For purposes of the present disclosure, the term “luggage” is used to refer to a passenger's belongings carried during a trip, such as suitcases, bags, backpacks, specialized equipment and various contents permitted for travel by air or other means, for example, ground transportation, encompassing both the containers and their contents (clothing, personal items, computer equipment, musical instruments, etc.). In some embodiments, the term “luggage” is also applicable to pets in suitable containers. The term “Artificial Intelligence” or “AI” is used to refer to a system comprising one or more processors that can perform tasks requiring human intelligence, but with limited or no human intervention which for purposes of the present disclosure refers specifically to techniques or applications programmed to perform specific tasks through the use of algorithms and/or through the training of a computational system. In non-limiting embodiments, these one or more processors may be implemented in hardware, firmware, or a combination of hardware and software. As used hereinafter, “real-time” refers to the capability of a system or process to receive, process, and respond to inputs or events within a timeframe that is imperceptible to the user or in accordance with the constraints of the application domain. In the context of machine learning, real-time denotes the ability to perform data processing, analysis, and decision-making instantly or within milliseconds, ensuring that the output or action is delivered virtually immediately after the input is received, thus enabling timely and responsive operation.

In this regard, the present disclosure comprises a system and methods for optimizing and managing the transportation of luggage of an airline passenger from a first location to a second location, through the use of a programmable device or computational system using Artificial Intelligence (AI), comprising:
(a) receiving via a user interface a passenger information, wherein said passenger information comprises: i) the flight information and reservation; ii) an address of a first location; iii) an address of a second location; iv) luggage parameters; and optionally v) pickup date and time at the first location;
b) generating routing options using Artificial Intelligence (AI) to provide routing options, as well as service times and costs;
c) scheduling luggage pickup using Artificial Intelligence (AI) to identify the appropriate logistics operator using at least one selection parameter for pick up luggage at the first location and delivery of such luggage to at least one first processing and inspection site;
d) picking up the luggage, identifying said luggage with passenger data and verifying the description of the luggage parameters and confirming the address of the second location;
e) optionally, attaching a GPS locator device into the luggage;
f) transferring the luggage to a first processing and inspection site;
g) processing and inspecting the luggage at the first processing and inspection site and verify the parameters of the luggage by evaluating at least one control parameter;
h) optionally, if the luggage does not meet at least one control parameter, scheduling the collection of the luggage using Artificial Intelligence (AI) to identify the suitable logistics operator by at least one selection parameter for pickup such luggage at a first processing and inspection site and delivery such luggage to the first location;
i) scheduling luggage pickup using Artificial Intelligence (AI) to identify the appropriate logistics operator by at least one selection parameter for transporting the luggage from the first processing and inspection site for delivery such luggage to at least one second processing and inspection site;
j) picking up the luggage at the second processing and inspection site, identifying the luggage with passenger data;
k) scheduling luggage pickup at the second processing and inspection site using Artificial Intelligence (AI) to identify the appropriate logistics operator by at least one selection parameter for transporting the luggage from the second processing and inspection site for delivery such luggage to at least one second location;
l) delivering the luggage to the second location and notifying the passenger; wherein the status and location of the luggage is monitored in real-time by a user interface.

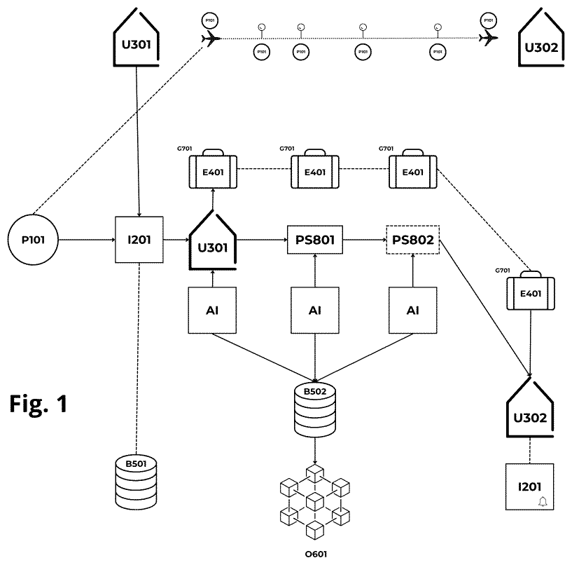

In a non-limiting embodiment, according to FIG. 1, the method comprises: receiving instruction and information by a passenger P101, via an interface I201, the information corresponding to the flight information and reservation, the address or coordinates of a first location U301, the address or coordinates of a second location U302 and the description of the luggage parameters E401; the flight reservation information is verified with the airline and all the provided information is stored in a database B501. Via incorporating artificial intelligence, from a weighted graph system to identify the best route and recursive non-binary tree systems to make a search among available options integrated with at least one search engine O601 that allows locating suitable airlines and logistics operators from at least one database B502 by means of at least one selection parameter for transport the luggage from a first location U301 to a second location U302 or by communication with logistics operators, route options, service times and costs are generated, and luggage pickup E401 is scheduled using at least one selection parameter for pickup at a first location U301.

The luggage is picked up at the first location U301, identifying the luggage E401 with the passenger data P101 and verifying the description of the luggage parameters; optionally, at least one GPS locator device G701 is attached to the luggage; and such luggage is transferred to a first processing and inspection site PS801.

At such first processing and inspection site PS801 the luggage is processed and inspected, and the luggage parameters are verified, evaluating at least one control parameter. In case the luggage does not comply with the at least one control parameter, the luggage is scheduled for pickup using Artificial Intelligence (AI) to identify the appropriate logistics operator through at least one selection parameter for pickup such luggage at the first processing and inspection site PS801 and delivery such luggage to the first location U301.

If the luggage E401 complies with the at least one control parameter, the luggage E401 is scheduled for pickup using Artificial Intelligence (AI) to identify the appropriate logistics operator through at least one selection parameter for transportation such luggage E401 from a first processing and inspection site PS801, and such luggage E401 is transferred to at least a second processing and inspection site PS802.

Then the pickup of luggage E401 is scheduled using Artificial Intelligence (AI) to identify the appropriate logistics operator through at least one selection parameter for transportation such luggage E401 from a second processing and inspection site PS802 for delivery such luggage E401 to at least a second location U302. Finally, the luggage E401 is delivered to the second location and the passenger P101 is notified.

In one embodiment, the first location U301 is any location elected by the passenger such as home, work office, home of a family member or acquaintance, a hotel or any other location in which the passenger indicates the luggage is located. In an optional embodiment, a maximum distance from a picking point can be established.

During the pickup, inspection and transfer of luggage, the passenger P101 moves from the first location U301 to the second location U302 or moves to additional locations without the luggage. The luggage transfer can be scheduled to perform the same sequence from the second location U302 to the first location U301.

In one non-limiting embodiment, transfers are optimized through geolocation systems and real-time routing guidance, as well as the search for the logistics operators with the lowest costs and closest distances to the different locations.

In one non-limiting embodiment, the luggage parameters E401 are selected from a number of pieces, type of luggage, luggage model (e.g. brand of the container(s)), material, luggage content, size and weight. The luggage parameters are also integrated as part of the data to determine the most appropriate routes and logistics operators for the transportation of such luggage.

In one non-limiting embodiment, from the number of pieces, size and weight, some type of packaging or protective attachment may be selected for the transportation of the luggage in order to ensure the integrity of such luggage, as well as to facilitate its handling.

In one non-limiting embodiment, the logistics operator is selected from private transportation services through an online platform, courier services, and pick-up and delivery service individuals. The type of transportation used by the logistics operator may be automobile, motorcycle, cargo vehicles, trucks, bicycle, airplane, train, bus, drone, robot, or any other means of transportation that allows picking up, approaching and transportation of the luggage.

In a non-limiting embodiment, the service operator is integrated into the present method through application platforms that already operate and have the necessary infrastructure for the transportation of the luggage.

In one non-limiting embodiment, the selection parameter for pickup and delivery at the first location or at the first or second processing and inspection site or at the second location is selected from: the frequency of departures and routes of logistics operators, departure and arrival times, load capacities, delivery, pickup or transportation times and cost, transit quantity, or combinations thereof, said selection parameter being managed from an Artificial Intelligence (AI) that by means of a mathematical and operational model between a graph system with “weights” to identify the best route and recursive non-n-ary (non-binary) tree systems to make a search among the available options, being said operational mathematical model integrated with at least one search engine that allows to locate the appropriate logistics operators with each of their routes, prices, times and limitations previously stored or available in at least one database.

In one non-limiting embodiment, the user interface I201 is integrated into a computer or computing device selected from a mobile device, a smartphone, a desktop computer, a laptop, a television, a tablet, in-vehicle devices or computers, virtual reality goggles, the metaverse, a smart watch, or combinations thereof, wherein the computing device has the capability to provide connectivity to the system over a network.

In one non-limiting embodiment, the method and system of the present disclosure are executed and performed by a computer or computing device as a computer-implemented method, through the use of computer-executable code or instructions.

Optionally, charging systems necessary to carry out payments by the user, as well as the billing and payment systems, are incorporated into the interface.

In one non-limiting embodiment, the user interface integrates a geolocation system or connection to a geolocation device to enable real-time monitoring of luggage.

The user interface has a system of notifications to the user for each process stage and in real-time on the route of the luggage, as well as a user support system in case of requiring any additional service or for the resolution of questions.

In one non-limiting embodiment, the system allows an interface or application function (e.g., a web services or mobile device application) to be configured in relation to a request from a passenger P101. The interface or application function may be displayed with visual or textual content that is dynamic and informative, such that it is relevant to the passenger P101. For example, an application function may be configured to allow the user to trigger the execution of a predefined action, or series of actions, for the purpose of facilitating the management of their request, such as travel and location, payment methods, GPS locator, preferences, luggage parameters or characteristics, among other event data detected in the user's records.

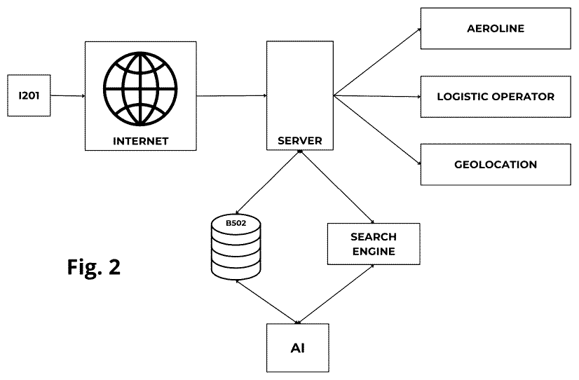

The entire process of generating instructions and communication between system participants is carried out using cloud-based linking technologies, connecting the passenger from at least one electronic device via the Internet with the airline, with at least one logistics operator and with at least one geolocation system, all participants being connected via a S902 server operating through Artificial Intelligence (FIG. 2).

According to the present disclosure, the logistics operator can be a company or natural person with the necessary infrastructure and elements to carry out the pickup, transportation and delivery of the luggage through some suitable means of transportation depending on the number of pieces, size and weight of the luggage. In one embodiment, the logistics operator is selected from one or more private transportation services by online platform, courier services, pick-up and delivery service individuals.

In this respect, the selection parameters for pickup and delivery at the first location or at the first or second processing and inspection site or at the second location are selected from frequency of departures and routes of logistics operators, departure and arrival times, load capacities, delivery, pickup or transportation times and cost, transit quantity, or combinations thereof.

The selection parameters for pickup and delivery are performed through Artificial Intelligence, selecting in an automated way the best qualified among two or more options.

Regarding the user interface, according to the present disclosure, it is integrated into a computer or computing device selected from a mobile device, a smart phone, a desktop computer, a laptop, a television, a tablet, in-vehicle devices or computers, virtual reality goggles, the metaverse, a smart watch, or combinations thereof, wherein the computing device has the capability to provide connectivity to the system over a network.

In one non-limiting embodiment, the user interface is operated through a service application adapted to the computer or computing device used, which enables the passenger P101 to access and use the service.

In one non-limiting embodiment, it requires that the computing or computing device used by the passenger has an information storage medium suitable for the operation of the interface, as well as for storing the passenger information and allowing the service application to run. The storage medium is selected from memory storage devices such as hard disks, external or portable storage drives, CD, DVD, USB, flash memory or storage servers.

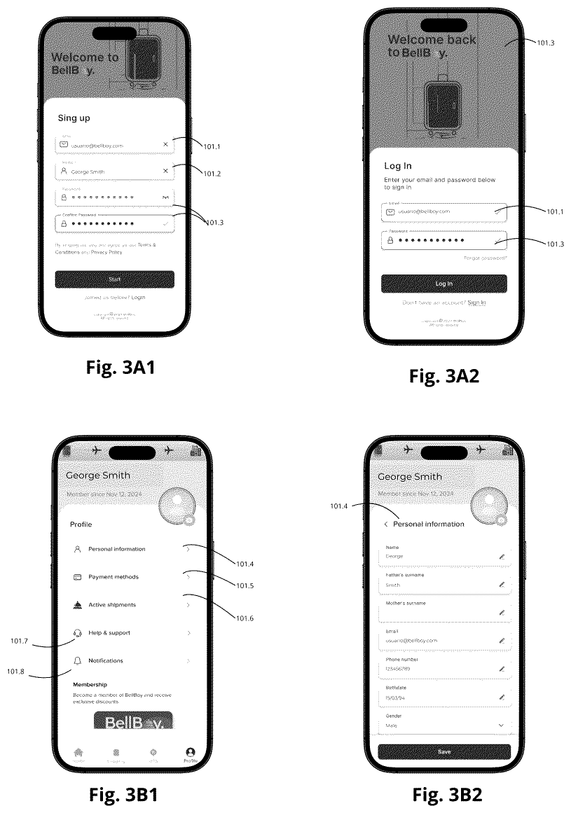

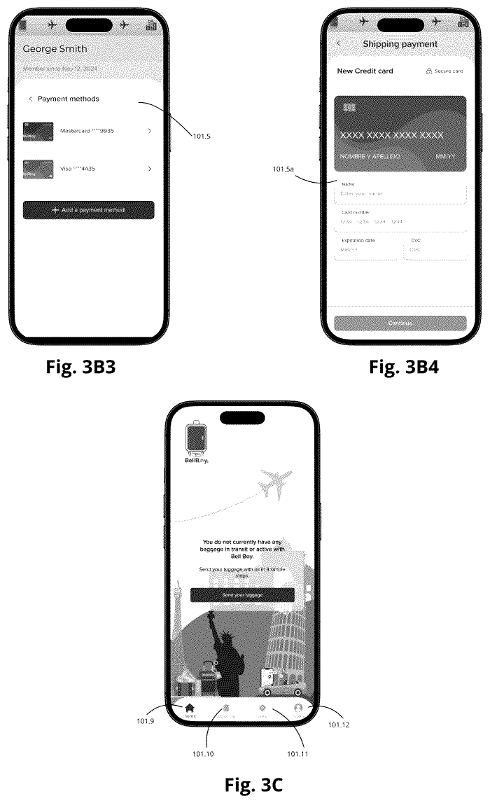

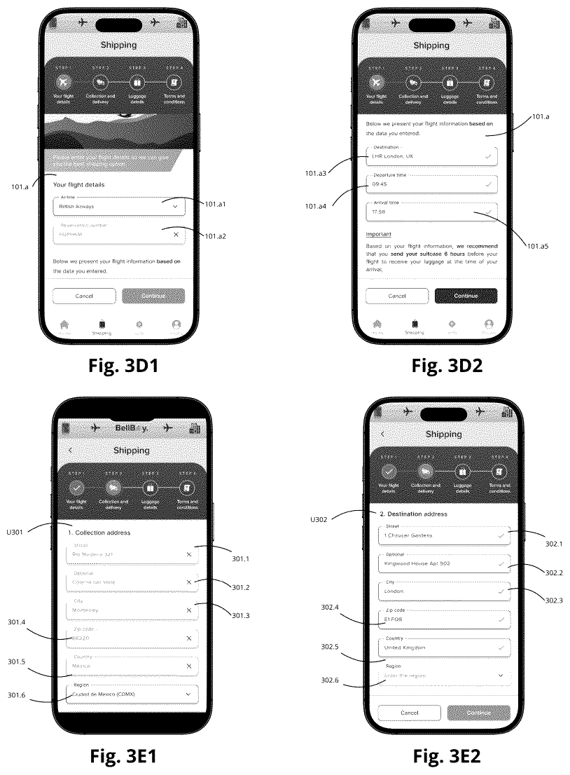

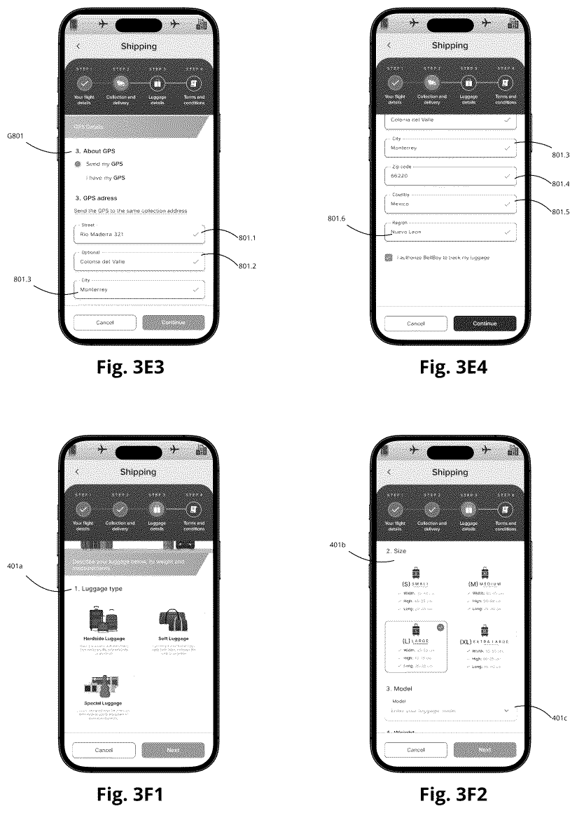

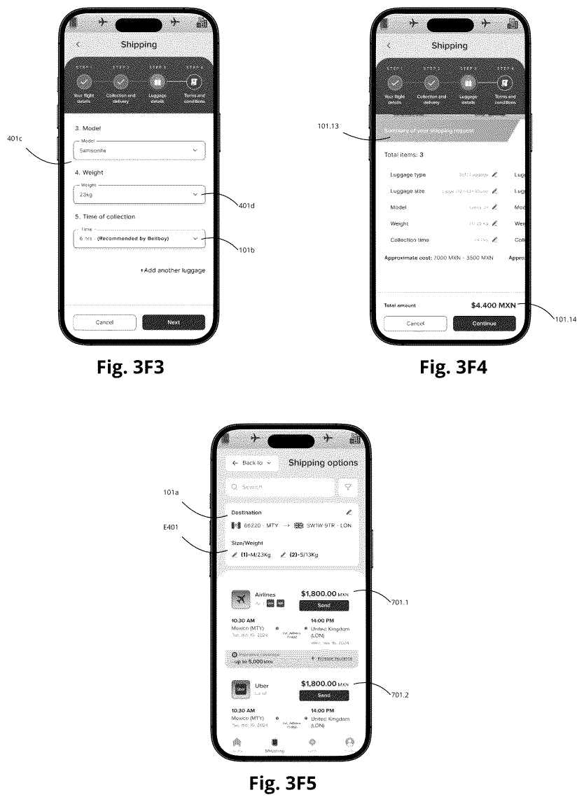

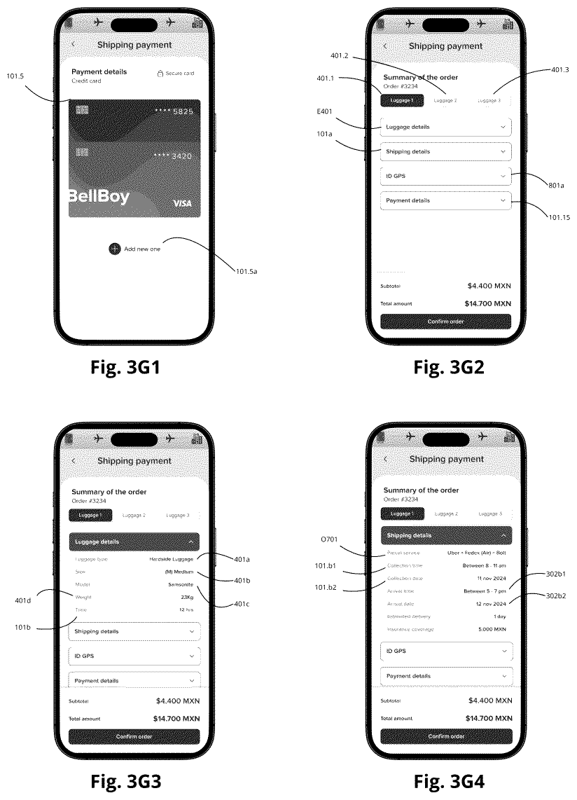

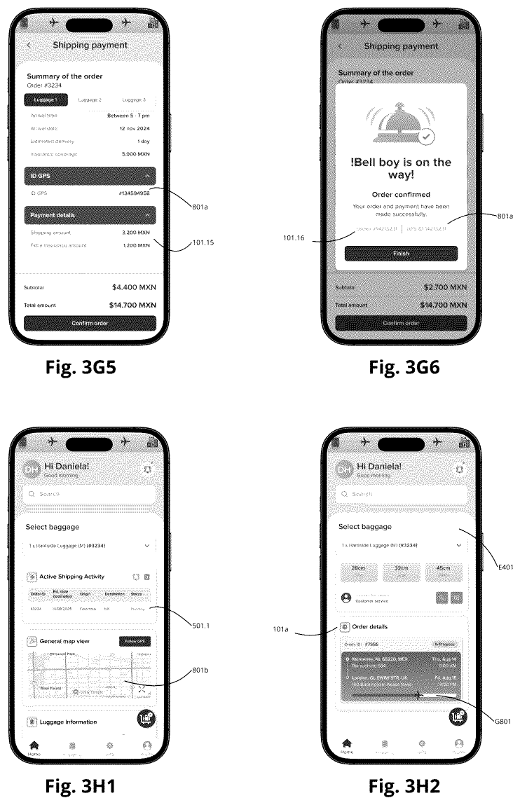

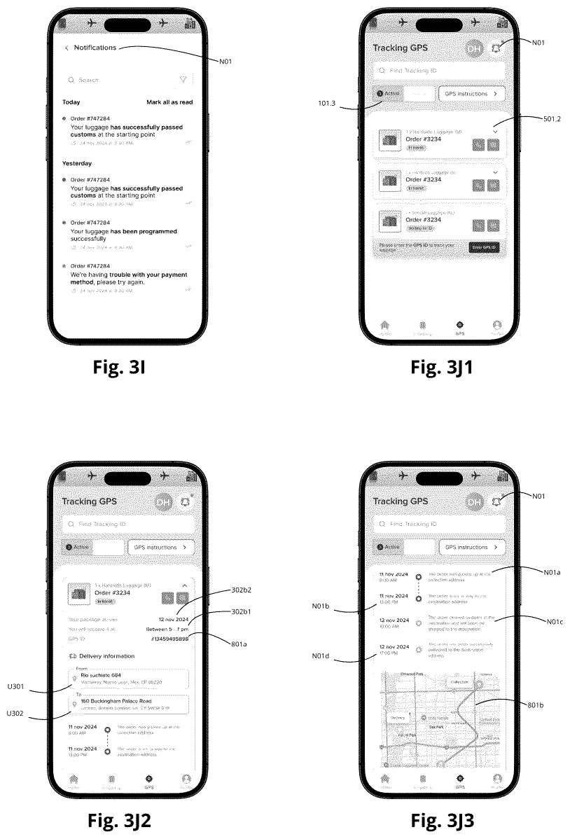

FIGS. 3A1 to 3J3 illustrate non-limiting embodiments of the interface for use by a service application on a mobile device.

In at least one of the non-limiting embodiments illustrated in FIGS. 3A1 to 3J3, in reference to FIG. 1 or 2, an interface I201 is shown, which may include multiple features selected from the different steps of the method subject to the present disclosure. The non-limiting embodiment shown in FIG. 3A1 shows fillable boxes for the registration of a passenger, wherein passenger P101 data may be required including at least the following information: email 101.1, a username 101.2 and a password 101.3, which may be in the form of a service request interface. In another non-limiting embodiment shown in FIG. 3A2, fillable boxes are shown for passenger login, where passenger data may be required including at least the following information: email 101.1 and a password 101.3.

In another non-limiting embodiment illustrated in FIG. 3B1, a summary of passenger data and luggage E401 shipments is shown, including at least the following information: personal information 101.4, payment methods 101.5, active shipments 101.6, help and support 101.7, and notifications 101.8, where the passenger data includes at least the following information: first name, last name, email, cell phone number, date of birth, and gender, as seen in the embodiment shown in FIG. 3B2.

In the non-limiting embodiments shown in FIGS. 3B3 and 3B4, passenger payment means and registration for a new passenger payment means are shown, respectively, including at least the following information: payment methods 101.5 and 101.5a and credit or debit card or other payment means data, wherein the payment means data includes at least the following information: card or payment means holder name, card number or payment means ID, card or payment means effective date, and card or payment means verification code or authentication means for the card or payment means.

In the non-limiting embodiment shown in FIG. 3C, a home screen is displayed when logged in, allowing the passenger to access the different tools of the interface, where these tools include icons for access to home 101.9, shipping 101.10, GPS 101.11 and profile 101.12.

FIGS. 3D1 and 3D2 show one non-limiting embodiment of the user interface, where the flight information and reservation 101a of the passenger is recorded, including at least the following information: airline name 101.a1, reservation number 101.a2, flight destination 101.a3, departure time 101.a4, and arrival time 101.a5.

FIG. 3E1 shows a user interface embodiment, wherein address information of the first location U301 is recorded, including at least the following information: street 301.1, city 301.3, zip code 301.4, country 301.5, region 301.6, and optional additional information 301.2. FIG. 3E2 shows one embodiment of the user interface, wherein second location address information U302 is recorded, including at least the following information: street 302.1, city 302.3, zip code 302.4, country 302.5, region 302.6, and optional additional information 302.2.

FIGS. 3E3 and 3E4 show one non-limiting embodiment of the user interface, wherein the option to attach a GPS locator device to luggage is selectable and the shipping address of the GPS locator device is recorded, with the option to select the address where the luggage is located, including at least the following information: street 801.1, city 801.3, zip code 308.4, country 308.5, region 308.6, and optional additional information 308.2.

FIGS. 3F1, 3F2, 3F3 show one non-limiting embodiment of a user interface, wherein the parameters of the luggage are selectable and/or fillable, including at least the following information: luggage type 401a, size 401b, model 401c, weight 401d and date and time of pickup 101b at the first location U301. Subsequently, the interface generates a summary of luggage parameters 101.13 and calculates a price 101.14 derived from the selected service as shown in FIG. 3F4.

In the non-limiting embodiment shown in FIG. 3F5, available routing options with transportation time and service cost estimates with at least one logistics operator is displayed, wherein at least the following information is included: flight information and reservation 101a, parameters of the luggage E401, at least one routing option with transportation time and service cost estimate with at least one logistics operator 701.1, 701.2.

FIG. 3G1 shows a non-limiting embodiment of a user interface wherein selectable passenger payment methods 101.5 showing data of credit or debit card or other preloaded passenger payment means and an option for registration of a new passenger payment means 101.5a are displayed.

FIGS. 3G2, 3G3, 3G4 and 3G5 show a non-limiting embodiment of the user interface, wherein shipment information is summarized, including at least the following information for each luggage 401.1, 401.2 and 401.3, flight information and reservation 101a, parameters of each luggage E401, GPS locator device ID number 801a, payment details 101.15, at least one selected logistics operator O701, the pickup time 101.b1, pickup date 101.b2, flight arrival time 302b1 and flight arrival date 302b2, wherein the parameters of the luggage E401 includes the information related to luggage type 401a, size 401b, model 401c, weight 401d and pickup date and time 101b at the first location U301.

FIG. 3G6 shows an order confirmation generated through the user interface, wherein at least the following information is displayed: order number 101.16 and GPS locator device ID number 801a.

FIGS. 3H1 and 3H2 show information related to active shipment in the user interface, wherein at least the following information is displayed: shipment status 501.1, a map 801b, parameters of the luggage E401 including information on luggage and pickup date and time 101b at first location U301, flight information and reservation 101a and monitoring of shipment progress via GPS info G801.

In the non-limiting embodiment shown in FIG. 3I, notifications N01 from the luggage transport status for an airline passenger from a first location U301 to a second location U302 are displayed.

In one non-limiting embodiment shown in FIGS. 3J1, 3J2, and 3J3, a real-time luggage location tracking is shown in GPS info G801, wherein at least the following information is displayed: in-route orders 501.2, flight arrival time 302b1, flight arrival date 302b2, GPS locator device ID number 801a, first location address U301, second location address U302, transportation progress notifications N01a, N01b, N01c, N01d, and real-time location map 801b.

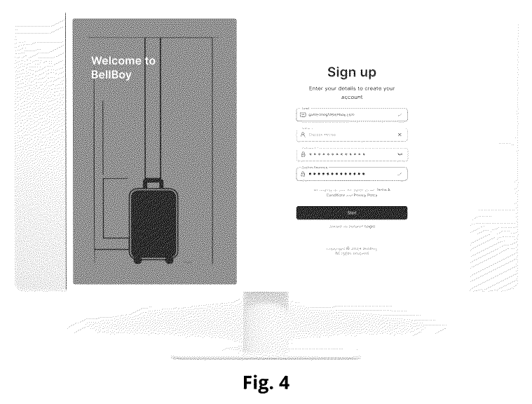

FIG. 4 shows a non-limiting example from the user interface adapted for use as a desktop application or on a Web site, integrating the steps described in FIGS. 3A1 to 3J3.

Among the advantages of the present disclosure are the following:
a. A system for pick-up, transportation and delivering luggage or equipment that allows the user making a trip to move about in complete freedom, comfort and safety.
b. Through the use of Artificial Intelligence, pickups, transportation and deliveries are optimized, minimizing pickup, transportation and delivery times, and the operating costs of the process are minimized.
c. The use of a desktop or mobile device application facilitates the user to request the service in a few steps and with the minimum of information required.
d. The system and methods facilitate, through its application, that people send their luggage to their final travel destination, connecting users with logistics and transportation companies.

What is claimed is:

1. A method for optimizing and managing transportation of a luggage for an airline passenger from a first location to a second location, or multiple locations, comprising:
a) receiving, via a user interface, passenger information comprising i) flight information and reservation; ii) an address of a first location; iii) an address of a second location; iv) parameters of a luggage; and optionally; v) pickup date and time at the first location;
b) storing the information provided in step a) in a database;
c) generating routing options with estimated transportation times and service costs with at least one logistics operator, using Artificial Intelligence from a weighted graph system to identify the best route and recursive non-binary tree systems to make a search among the available options integrated with at least one search engine that allows locating suitable airlines and logistics operators from at least one logistics operator database, through at least one selection parameter for transportation from the first location to the second location;
c) scheduling the pickup of luggage using Artificial Intelligence (AI) from a weighted graph system to identify the best route and recursive non-binary tree systems to make a search among available options integrated with at least one search engine that allows locating suitable airlines and logistics operators from at least one airlines and logistics database, through at least one selection parameter for the transportation from a first location;
d) picking up the luggage from the first location, identifying the luggage or equipment with the passenger data and verifying the parameters of the luggage and confirming the address of the second location;
e) transporting the luggage to a first processing and inspection site;
f) processing and inspecting the luggage at the first processing and inspection site and verify the luggage parameters, at least one control parameter;
g) scheduling the pickup of luggage using Artificial Intelligence (AI), from a weighted graph system to identify the best route and recursive non-binary tree systems to make a search among the available options integrated with at least one search engine that allows locating the suitable logistics operator from at least one logistics operators database, through at least one selection parameter for transportation such luggage from a first processing and inspection site for delivery to at least a second processing and inspection site;
h) picking up the luggage at the second processing and inspection site, identifying the luggage with the passenger data;
i) scheduling the pickup of the luggage from the second processing and inspection site using Artificial Intelligence (AI) from a weighted graph system to identify the best route and recursive non-binary tree systems to make a search among the available options integrated with at least one search engine to allow locating the suitable logistics operator from at least one logistics operators database, through at least one selection parameter for the transportation such luggage from a second processing and inspection site for delivery such luggage to at least one second location; and
j) delivering the luggage to the second location.

2. The method of claim 1, wherein the parameters of the luggage are selected from at least one of the following: type of luggage, size, model or weight, or any combination thereof.

3. The method of claim 1, wherein the logistics operator is at least one of the following; private transportation services through online platform, courier services, pick-up and delivery service individuals, or any combination thereof.

4. The method of claim 1, wherein the selection parameter for pickup and delivery at the first location or at the first or second processing and inspection site or at the second location is at least one of the following: the frequency of departures and routes of logistics operators, departure and arrival times, load capacities, delivery, pickup or transportation times and costs, transit quantity, or any combination thereof.

5. The method of claim 1, wherein the user interface is integrated into a computer or computing device comprising at least one of the following: a mobile device, a smartphone, a desktop computer, a laptop, a television, a tablet, in-vehicle devices or computers, virtual reality goggles, the metaverse, a smart watch, or any combination thereof.

6. The of claim 1, wherein the GPS locator device on the luggage has a GPS locator device ID number.

7. The method of claim 1, further comprising, after step d), attaching a GPS locator device to the luggage.

8. The method of claim 1, wherein, the user interface operates through a web services application or on a mobile device.

9. The method of claim 1, wherein through the user interface the passenger is notified in at least one step of the method.

10. The method of claim 1, wherein, after step h), if the luggage does not comply with the at least one control parameter, scheduling the pickup of the luggage using Artificial Intelligence (AI) from a weighted graph system to identify the best route and recursive non-binary tree systems to make a search among the available options integrated with at least one search engine to allow locating the suitable logistics operator from at least one logistics operators database, through at least one selection parameter for pickup.

11. The method of claim 9, wherein the luggage at a first processing and inspection site is delivered to the first location.
